(19) United States
(12) Patent Application Publication
(10) Pub. No.: US 2023/0115203 A1
(43) Pub. Date: Apr. 13, 2023

(54) CRYSTAL-COATED BNNT SCINTILLATORS

(71) Applicant: BNNT, LLC, Newport News, VA (US)

(72) Inventors: R. Roy WHITNEY, Newport News, VA (US); Thomas W. HENNEBERG, Newport News, VA (US); Clay F. HUFF, Newport News, VA (US); Lyndsey R. SCAMMELL, Newport News, VA (US)

(21) Appl. No.: 17/794,161

(22) PCT Filed: Jan. 21, 2021
(86) PCT No.: PCT/US2021/014288

§ 371 Date: Jul. 20, 2022

Related U.S. Application Data
(60) Provisional application No. 62/963,828, filed on Jan. 21, 2020.

(51) Int. Cl. C01B 21/064; G01T 3/06

(52) U.S. Cl. CPC C01B 21/064; G01T 3/06; C01P 2004/02; C01P 2004/13

(57) ABSTRACT

Boron nitride nanotubes (BNNTs) having a second scintillating material, and in some embodiments an enhanced 10B content, may be used for efficient thermal neutron detection. The second scintillating material may be a crystal coating on the nanotubes, and/or crystal dispersed within the BNNT material. Crystal-coated BNNT materials enable detecting thermal neutrons by detecting light from the decay products of the thermal neutron’s absorption on the 10B atoms in the BNNT material, as the resultant decay products pass through the crystal-coating. Embodiments of thermal neutron detectors are described. Methods for preparing BNNTs with a second scintillating material are also described.

### STATEMENT REGARDING GOVERNMENT SUPPORT

None.

### FIELD OF THE INVENTION

The present disclosure relates to detecting ionization radiation, and more particularly thermal neutrons and fast neutrons.

### BACKGROUND - INTRODUCTION

Thermal neutron detectors usually employ materials with ¹⁰B (boron with 10 nucleons, i.e. 5 protons and 5 neutrons) or ³He (2 protons and 1 neutron). ¹⁵⁷Gd, ⁶Li and a few other isotopes are also sometimes used but methods for incorporating them in large volume detectors have not been developed with the exception of some ⁶Li-based efforts.

Natural boron is approximately 20% ¹⁰B and 80% ¹¹B. The ¹⁰B-based detectors are more common because almost all ³He comes from reprocessing nuclear waste, ³He is in high demand, and ³He is consequently very expensive. Most ¹⁰B-based detectors utilize BF₃ and are typically a few cm in diameter with the BF₃ at typically from one half to three atmosphere pressure. BF₃ is toxic and must be carefully contained. For ¹⁰B, ³He and ⁶Li-based detectors, most employ systems to detect the electronic pulses or light coming from the ionization produced by the resultant decay products as the ions slowdown in surrounding media. A variety of ionization chambers, multi wire proportional chambers (MWPC), gas electron multiplier (GEM), straw tube, solar blind photomultipliers, solid state photomultipliers (SiPMs), linear strip sensors, etc. are used. Typical sizes for BF₃-based thermal neutron detectors are several cm in diameter and length and with associated high voltages in the range of 1,500 - 2,000 volts. Sizes of ³He-based thermal neutron detectors range from a few cm in most dimensions to ones for scientific research that may approach a meter in area with a several cm in thickness and may involve multiple ³He tubes. ⁶Li-based detectors typically disperse ⁶Li in various plastic scintillator materials though some have decay products produce ionization light in gases. To achieve adequate sensitivity, ³He-based detectors frequently require operation at pressures of several atmospheres, the addition of other gases such as propane and CF4, and a range of high voltages.

³He has a large cross section of 5,330 barns for the absorption of thermal neutrons and the reaction proceeds as:

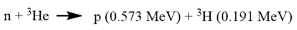

While ³He has certain advantages in some implementations for achieving relatively high spatial resolution, ³He-based detection has drawbacks due to its limitations for making large, lightweight, and efficient thermal neutron detectors that can operate well at atmospheric pressure as well as at pressures from 0.001 atmosphere to over 5 atmospheres.

The primary limitation for some ⁶Li-based detectors is that they typically require a solid or liquid scintillation material that results in unwanted background signals from other ionizing particles that may be present in the environment. More recent ⁶Li-based detectors utilize low pressure gases for the production of scintillation light. In addition, the ⁶Li cross-section for absorption of thermal neutrons is less than the ¹⁰B cross section for absorption of thermal neutrons.

¹⁰B has a large cross section of 3,835 barns for the absorption of thermal neutrons that can be exploited for the detection of the presence of thermal neutrons. The thermal neutron absorption reaction proceeds as:

$$\begin{matrix}94 \% : \text{n} + {}^{10} \text{B} \to {}^{11} {\text{B}}^{∗} \to {}^{4} \text{He} \left(1.47 \text{MeV}\right) + {}^{7} \text{Li} \left(0.84 \text{MeV}\right) + \\ \text{gamma} \left(0.48 \text{MeV}\right)\end{matrix}$$

$$6 \% : \text{n} + {}^{10} \text{B} \to {}^{11} {\text{B}}^{∗} \to {}^{4} \text{He} \left(1.78 \text{MeV}\right) + {}^{7} \text{Li} \left(1.02 \text{MeV}\right)$$

The ¹¹B* state lasts about 1E-12 seconds. The gamma, when present, comes from the decay of an excited state of ⁷Li.

Following absorption of the neutron the ⁴He and ⁷Li lose their kinetic energy by ionization loss in the surrounding material and the 0.48 MeV gamma, when present, is absorbed by the surrounding material. The occurrence of the neutron absorption on the ¹⁰B can be inferred by detecting the ionization losses of the ⁴He and ⁷Li ions or for 94% of the decays or by detecting the 0.48 MeV gamma when present. Some systems do both. For example, in some media the ionization losses produce light that can be detected by photon detectors such as photomultiplier tubes, solar blind photomultipliers, SiPM arrays, large area avalanche photodiodes (LAAPD), etc. MWPCs, GEMs, straw tube and linear strip detectors that collect the ion pairs created in the surrounding media can also be used

Position and time sensitive fast neutron detectors often employ scattering (also known as recoil) methods where the fast neutrons scatter from light nuclei, such as protons or helium (⁴He), to produce the respective recoiling protons or helium ions that then ionize the surrounding materials. The ionization energy is then detected by scintillation or proportional counters. Issues with this methodology include relatively low efficiency and background noise from the inclusion of relatively low energy, i.e. slow, neutrons and other particles in the signal. Thermalizing fast neutron detectors infer the existence of fast neutrons by first slowing the fast neutrons in hydrogen-rich moderators and then detecting the thermal neutrons. All of these methods also have issues with eliminating gamma ray backgrounds through a variety of techniques to include pulse shape discrimination. In addition, the thermalizing methods also spread the signal that can be much less than a microsecond to time periods of many tens to hundreds of microseconds. In addition, methods that rely on producing thermal neutrons for fast neutron detection have backgrounds from the presence of other thermal neutrons that are typically present. Fast neutron fission chambers are available that typically use proportional counter technology. They have good rejection of gamma rays and when made with 238U as primarily sensitive to fast neutrons. The neutron fission chambers may have good timing resolution, but typically are limited in spatial resolution and total cross-section.

Additionally, scintillating materials in general are used for monitoring positions and intensities of x-ray, gamma ray, and non-relativistic and relativistic ionizing particles and beams thereof. In some cases, the neutron absorption material such as ⁶Li, ¹⁰B and ¹⁵⁷Gd are embedded in electronic components as part of an integrated circuit and the absorption triggers a change in state of one of the components leading to detection of the neutron.

What is needed, then, are scintillators capable of taking full advantage of ¹⁰B as a neutron absorption material, capable of achieving the spatial resolution and total cross-section needed for many applications, and detection devices capable of employing such scintillating materials with high efficiency and reduced background noise.

### BRIEF SUMMARY

This disclosure relates to the use of crystal-coated boron nitride nanotube (BNNT) scintillating materials, and detectors using crystal-coated BNNT scintillating materials for efficiently detecting ionization radiation, including thermal neutrons and fast neutrons, with minimal background noise. Under the present approach, BNNT material is used as a scintillator in a radiation detector. In embodiments of the present approach, the BNNT material includes microscale crystals of a second scintillating material. The microscale crystals may coat individual BNNTs in the BNNT material, and in some embodiments may be dispersed within and surrounding the BNNT material. Inclusion of the microscale crystals with the BNNT material enhances the light output from the neutron absorption Events. In early prototypes, as-produced BNNT material in various form-factors served as the scaffold for stably distributing ¹⁰B (boron-10) in a scintillating material (e.g., a solid, liquid, or gas). The early prototypes used the “puff ball” form-factor, representative of as-produced BNNT material synthesized using high temperature, high pressure processes, available from BNNT, LLC (Newport News, Virginia, USA). Subsequent prototypes used BNNT buckypapers (defined as nonwoven mats of high quality BNNT material). It should be appreciated that various methods are available to form a BNNT buckypaper. In some preferred embodiments, a BNNT buckypaper is formed through dispersing BNNT material in a solvent, filtering the BNNT dispersion, collecting BNNTs on a filter, and drying the solvent to form a solid BNNT material on the filter). Prototype detectors featuring the BNNT material as a BNNT buckypaper were placed in electron beams, and light was observed with beam currents near one microamp. However, with the high currents of relativistic electrons and the simple cameras used for the observations, there was an initial uncertainty about whether the light was from scintillation, optical transition radiation (OTR), or a combination of both. Auto-adjusting cameras were used for the initial tests, which provided no information on light intensities and pulse timing. Most of the cameras used were black and white, but the few color cameras used appeared to show that the light was somewhat blue. Both scintillation and OTR could result in blue light under the testing conditions. Prototyping and assessment work using BNNT buckypapers for monitoring beams is ongoing. However, the results and advancements described herein, and relating to BNNT scintillation, provide significant improvement to signal detection.

Initial prototype neutron detectors using BNNT materials were tested using different scintillating gases. These scintillating gases included argon, nitrogen, and xenon. Argon scintillates at 175 nm (7.1 eV) and Xenon scintillates at 128 nm (9.7 eV). Both of these wavelengths are below the 210 nm (5.9 eV) bandgap excitation wavelength of typical hexagonal boron nitride (h-BN) materials. Consequently, self-absorption was high and only small amounts of light were observed, even though these two gases have photon outputs in the range of 15,000 -20,000 photons per MeV of deposited energy. Nitrogen scintillates over a range of 300 - 400 nm (4.1 - 3.1 eV), i.e., above the h-BN bandgap, but the nitrogen has roughly 2,000 photons per MeV at atmospheric pressure. However, thermal neutron absorption Events appeared to be observed with sufficient signal-to-noise to warrant further analysis of nitrogen as the scintillating gas. For embodiments using nitrogen, the gas pressures were varied from above atmospheric pressure (~101 kPa) to below atmospheric pressure (e.g., 80 kPa, 60 kPa, 40 kPa, 20 kPa, 10 kPa, 5 kPa, 3 kPa, 1 kPa, 0.5 kPa, 0.1 kPa, 0.05 kPa, and 0.02 kPa), with improvement in signal-to-noise as the nitrogen went to the region of 0.02 - 1 kPa. However, the light pulse was typically many microseconds wide, whereas a narrower pulse width would be preferred.

Dramatic signal increases resulted when the BNNT material was embedded within and, in some embodiments, coated with a second scintillating material. The second scintillating material was, in some embodiments, a crystallized polymer scintillator. The results using this prototype indicate that thermal neutron detectors using ¹⁰B in enriched BNNT (“¹⁰BNNT”) at least match, and in some embodiments exceed, the scintillating performance of ³He-based thermal neutron detectors. The BNNT-based scintillators of the present approach enable high-efficiency, low-power, and low-weight thermal neutron detection apparatus and methods. Further characterization of the ¹⁰BNNT in various form-factors is underway, and new geometries utilizing ¹⁰BNNT will allow for economical and high-rate, sub-millimeter resolution detection. It should be appreciated that these advances may be applied in radiation detection and source location in scientific, portal monitoring, and space-related applications, among other potential applications of the present approach.

Under the present approach, “high quality BNNTs” are preferable for use as the BNNT material in most embodiments. As used herein, high quality BNNTs are produced by catalyst-free, high temperature, high pressure synthesis methods, have few defects, no catalyst impurities, 1- to 10-walls with a peak in wall distribution at 2-walls, and rapidly decreasing with larger number of walls. BNNT diameters typically range from 1.5 to 6 nm but may extend beyond this range, and lengths typically range from a few hundreds (e.g., about 1 to about 5, and in some embodiments, about 2 to about 5, and in some embodiments, about 3 to about 5, wherein the term “about” in this context means +/- 0.2) of nm to hundreds of microns, though depending on the synthesis process and conditions the lengths may extend beyond this range. For the as-produced BNNT material, high quality BNNTs typically make up about 50% of the bulk material, and boron particles, amorphous BN, and h-BN may be present as a result from the synthesis process. As used herein, “boron particle(s)” refers to free boron existing apart from other boron species. The synthesis operating conditions may be adjusted to change the composition of boron particles, relative to the amorphous BN and h-BN species, remaining in the BNNT material. Reducing boron particle content typically increases the optical transparency of the bulk BNNT material, which may be advantageous for some embodiments of the present approach. Various purification processes can be used to remove boron particulates, BN, and h-BN, including those disclosed in co-pending International Patent Application No. WO 2018/102423 A1, filed Nov. 29, 2017, which is incorporated by reference in its entirety. The reduction of non-BNNT allotropes may improve the sensitivity of detectors under the present approach, but it should be appreciated that the present approach is not limited to a particular quality of BNNT materials or relative content of non-BNNT species, unless explicitly stated otherwise.

Embodiments of the present approach may take the form of a boron nitride nanotube (“BNNT”)-based scintillating material having a BNNT material made of a plurality of BNNTs, and a crystalline scintillating material. The crystalline scintillating material may be a coating on the BNNTs, and/r may be dispersed within the BNNT material. In some embodiments, the BNNT material is made of BNNTs having an enhanced fraction of ¹⁰B. The enhanced fraction of ¹⁰B may be, for example, at least 50% by weight, 60% by weight, 70% by weight, 80% by weight, 90% by weight, and 95% by weight, determined before coating the BNNT material and/or dispersing the crystalline scintillating material in the BNNT material. It should be appreciated that several organic and inorganic crystalline scintillating materials are available. For example, the crystalline scintillating material may be one of anthracene, stilbene, and naphthalene. Other examples of crystalline scintillating materials are described below.

Some embodiments may feature multiple layers of a BNNT material and a crystalline scintillating material. In some embodiments, the BNNT-based scintillating material may have BNNTs aligned in a first direction, such as in a radial direction resulting from forming a BNNT buckypaper. Some embodiments may use a BNNT buckypaper for the BNNT material. In some embodiments, the BNNT material has a residual boron content of less than 20% by weight, or less than 10% by weight, or less than 1% by weight, or less than 0.5% by weight.

The present approach may take the form of a BNNT-based neutron detector in some embodiments. Generally, a BNNT-based neutron detector may have a chamber housing at least one photon detector, a BNNT-based scintillating material having a BNNT material and a crystalline scintillating material. The crystalline scintillating material may be a coating on the BNNTs, and/or may be dispersed within the BNNT material. The photon detector is positioned for detection of photons emitted from ions traversing the scintillating material, as a result of neutron absorption in the chamber. It should be appreciated that any of the BNNT scintillating materials described herein may be used in a BNNT-based neutron detector. In some embodiments, the chamber may include at least one mirror surface positioned to reflect photons toward the photon detector. In some embodiments, the BNNT-based neutron detector may include one or more fiber optic inverse side-glow (FOIS) cables positioned to transport collected light to the at least one photon detector. A FOIS cable may include a frosted portion having a coating of one of a crystalline scintillating material. The frosted portion may be coated with a BNNT material having a coating of a crystalline scintillating material.

Some embodiments of the present approach may take the form of a method for producing a boron nitride nanotube (“BNNT”)-based scintillating material. For example, some methods may involve dispersing a BNNT material in a solvent, dispersing a crystal precursor of a scintillating material in the solvent, pouring the dispersed BNNT material and dispersed crystal precursor onto a surface, and evaporating the solvent to form a crystal-coated BNNT scintillating material on the surface. The crystal precursor may be an organic scintillating material such as one of anthracene, stilbene, and naphthalene. It should be appreciated that the crystal precursor must be soluble in the solvent used, which may be an organic solvent in some embodiments. The pouring the dispersed BNNT material and dispersed crystal precursor onto a surface and evaporating the solvent to form a crystal-coated BNNT scintillating material on the surface, may be repeated to form a layered crystal-coated BNNT scintillating material. It should be appreciated that the BNNT material may have BNNTs with an enhanced fraction of ¹⁰B, as described herein. It should also be appreciated that the BNNT material may have a residual boron content of less than 20% by weight, less than 10% by weight, less than 1% by weight, or less than 0.5% by weight.

In other embodiments of the present approach, the method for producing a BNNT-based scintillating material may involve dispersing a crystal precursor in a solvent, wherein the crystal precursor is a scintillating material, pouring the dispersed crystal precursor over a BNNT material, and evaporating the solvent to form a crystal-coated BNNT scintillating material. The crystal precursor may be a crystalline scintillating material as described herein. It should be appreciated that pouring the dispersed crystal precursor onto the BNNT material and evaporating the solvent may be performed multiple times to form a layered crystal-coated BNNT scintillating material. In some embodiments, the BNNT material may have BNNTs having an enhanced fraction of ¹⁰B. In some embodiments, the BNNT material has a residual boron content of less than 20% by weight, or less than 10% by weight, or less than 1% by weight, or less than 0.5% by weight. In some embodiments of this method, the BNNT material may be a BNNT buckypaper.

In yet other embodiments of the present approach, the method for producing a BNNT-based scintillating material may involve dispersing a BNNT material in a first solvent to form a first solution; dispersing a crystal precursor in a second solvent to form a second solution, wherein the crystal precursor is a scintillating material; combining the first solution and the second solution at a desired ratio to form a combined solution; incrementally adding to the combined solution a third solvent in which the crystal precursor is immiscible, to induce crystal formation; and extracting the first solvent, the second solvent, and the third solvent, to form a crystal-coated BNNT material. The crystal precursor may be a crystalline scintillating material as described herein. In some embodiments, the BNNT material may have BNNTs having an enhanced fraction of ¹⁰B. In some embodiments, the BNNT material has a residual boron content of less than 20% by weight, or less than 10% by weight, or less than 1% by weight, or less than 0.5% by weight. Extracting the first solvent, the second solvent, and the third solvent, may, in some embodiments, be accomplished through vacuum filtration, and the crystal-coated BNNT material comprises a crystal-coated BNNT buckypaper.

### DESCRIPTION OF THE DRAWINGS

FIG. 1 illustrates neutron absorption on ¹⁰B, which produces a ⁴He - ⁷Li pair of ions emitting light in the surrounding material.

FIG. 2 illustrates BNNT material embedded with scintillating crystals.

FIG. 3 is an image of a BNNT buckypaper having a 21.5 cm diameter.

FIG. 4 is an image of a BNNT buckypapers over a pencil.

FIG. 5 shows a fragment of BNNT buckypaper embedded and coated with scintillating crystals under UV light illumination on some sections.

FIG. 6 shows an optical microscope image anthracene crystals on BNNT buckypaper.

FIG. 7 illustrates scintillating crystal-coated BNNT material as a buckypaper in a tube with light being collected by a SiPM or PMT.

FIG. 8 illustrates an FOIS neutron detector with a photon detector at one end according to an embodiment of the present approach.

FIG. 9 illustrates an FOIS neutron detector with photon detectors at two ends according to an embodiment of the present approach.

FIG. 10 illustrates one end of an FOIS neutron detector according to an embodiment of the present approach.

### DETAILED DESCRIPTION

The present approach relates to the advantageous use of BNNT materials, and in particular high-quality BNNT materials, having a second scintillating material. The second scintillating material may be, for example, a scintillating crystalline polymer, and may be coated on the BNNTs, and/or dispersed within the BNNT material. It should be appreciated that some embodiments may include the second scintillating material as a coating on the BNNTs in the BNNT material, and some embodiments may include the second scintillating material dispersed within the BNNT material, and some embodiments may have the second scintillating material as both a coating on the BNNTs and dispersed within the BNNT material.

There are numerous advantages in utilizing high-quality BNNT materials in embodiments of the present approach. For example, with appropriate refining to reduce the content of boron particles to less than 1 wt.%, and in some embodiments below 0.2 wt.%, and in some embodiments removing some of the non-BNNT, BN allotropes to less than 30 wt.% and in some embodiments below 10 wt.%, is that the BNNT materials become optically translucent and allow the light produced by either the scintillating crystals or the BNNT themselves, to reach a photon detector (e.g., a the SiPM or PMT photon detector). In some embodiments, the BNNT material is under vacuum or partial vacuum. However, another advantage of preferred embodiments of the present approach is that the second scintillating material, in crystalline form, is stable in air, and air is transparent to the wavelengths of many scintillating crystals. In some embodiments, the BNNT material comprises an enhanced concentration of ¹⁰B in the nanotubes. Boron naturally occurs as stable isotopes ¹⁰B and ¹¹B, but ¹¹B makes up about 80% of natural boron. Increasing the relative concentration of ¹⁰B to ¹¹B, increases the locations for neutron absorption. For example, in some embodiments at least 50% of the boron in the BNNT material may comprise ¹⁰B, and in some embodiments at least 60%, and in some embodiments at least 70%, and in some embodiments at least 75%, and in some embodiments at least 80%, and in some embodiments at least 85%, and in some embodiments at least 90%, and in some embodiments at least 95%, and in some embodiments at least 99%. (Note that unless otherwise stated, a percentage of a component in a material is a weight percentage.) References to the percentage of boron comprising ¹⁰B relate to the boron feedstock used to synthesize BNNTs, and thus the isotope content of the as-produced BNNT material. For example, at least 50% of the boron in the BNNT material being ¹⁰B means that at least 50% of the boron feedstock used for synthesizing the BNNT material was ¹⁰B. The following discussion describes the present approach in the context of various embodiments.

Under the present approach, BNNTs provide a mechanism to distribute ¹⁰B in a low atomic number, scintillating material. FIG. 1 is a diagram of a scintillating chamber 18 having a crystal-coated BNNT material 13. As illustrated in FIG. 1, the BNNT material includes a second scintillating material, crystalized, as a coating and/or dispersed throughout the BNNT material (referred to as a crystal-coated BNNT material 13). When a neutron 11 interacts with a ¹⁰B atom 12 in a BNNT or other boron, amorphous BN, or h-BN species in the crystal-coated BNNT material 13, including any scintillating crystals present, the ⁴He ion 14 and ⁷Li ion 15 (and possibly gamma) are produced and travel into the surrounding crystal-coated BNNT material 13. The BNNT, boron, amorphous BN, and h-BN in the crystal-coated BNNT material 13 are minimally changed or impacted by neutron absorption Events, provided that the fraction of material interacted with by the neutron absorption does not exceed 5% by weight in most embodiments, and in some embodiments as high as 20% of the overall material as long as the average structural integrity is preserved and the optical transmission of the light is not compromised. The range relates to some embodiments having elements that hold the material in place (and therefore the threshold is higher, e.g., around 20%), wherein other embodiments the material is part of the support structure and therefore the threshold is lower (e.g., around 5%). The ⁴He ion 14 gains electrons and remains as a mobile gas species in the crystal-coated BNNT material 13, whereas the ⁷Li ion 15 may bond to the BNNT, boron, amorphous BN, or h-BN, or in some cases to the surrounding scintillation material if it is other than a noble gas or nitrogen gas. The ⁷Li bonding has little impact, if any, on the boron species and scintillators, provided that the boron species bonded with ⁷Li represents a small fraction (e.g., less than 5%, and in embodiments having support for the BNNT material, less than 20%) of the bulk material as long as the average structural integrity is preserved. In most embodiments, the about of boron species bonded with ⁷Li is much less than these threshold amounts, due to the amount of crystal-coated BNNT material present in the embodiment. The ⁷Li ion 15 may alternatively interact with the surrounding gas or other material that may be present in containment volume 18, including the volume 18 itself. The ⁷Li ion 15 interaction might become an issue if the amount of neutrons being absorbed, i.e., the number of Events, was extremely high, as in the case of placing the detector in close proximity of a nuclear reactor core. Note, for some BF₃ systems there is a related issue of fluorine atoms releasing from the scaffold that interfere with some modes of detecting the decay signals. The fluorine atom release can become an issue for BF₃ at a relatively lower number of Events compared to BNNT-based detectors. The 0.48 MeV gammas are very penetrating to most materials, and largely escape any detector not explicitly designed to stop them.

With reference to the embodiment shown in FIG. 1, neutrons may be detected based on a four step process: 1) absorption of the neutron on ¹⁰B (the “Event”); 2) decay of the resultant excited state ¹¹B*; 3) ⁴He and ⁷Li decay products traverse and ionize the surrounding BNNT and scintillating crystals; and 4) detect the resultant scintillation photons. Processes 1) and 2) proceed as:

$$\begin{matrix}94 \% : \text{n} + {}^{10} \text{B} \to {}^{11} {\text{B}}^{∗} \to {}^{4} \text{He} \left(1.47 \text{MeV}\right) + {}^{7} \text{Li} \left(0.84 \text{MeV}\right) + \\ \text{gamma} \left(0.48 \text{MeV}\right)\end{matrix}$$

$$6 \% : \text{n} + {}^{10} \text{B} \to {}^{11} {\text{B}}^{∗} \to {}^{4} \text{He} \left(1.78 \text{MeV}\right) + {}^{7} \text{Li} \left(1.02 \text{MeV}\right)$$

The ¹¹B* state lasts about 10⁻¹² seconds. The gamma, when present, comes from the decay of an excited state of ⁷Li. The total ionization energy available is either 2.31 MeV (94%), assuming no absorption of the gamma, or 2.80 MeV (6%).

In some embodiments, detection of ⁴He ion 14 and ⁷Li ion 15 produced in the neutron 11 absorption on ¹⁰B 12, the Event, can be achieved in a two-step process: 1) surround BNNTs in the BNNT material 13 and any boron, amorphous BN, and h-BN impurities, with a second scintillating material 16 (e.g., a solid, gas or liquid scintillator), such that as the ⁴He 14 and ⁷Li 15 ions lose energy through ionization in the second scintillating material, light is emitted along the ionization path 17; and 2) collect the emitted light and convert it to an appropriate electronic signal (photon detector not shown). The second step is generally known in the art, and suitable techniques and apparatus for collecting light, converting the light to an electronic signal, and measuring the signal are available to the person having an ordinary level of skill in the art. However, the embodiments described below provide improved light collection relative to contemporary alternatives. The second scintillating material 16 can be a solid, liquid, or gas. In the preferred embodiment discussed herein, the second scintillating material is a crystal coating and, in some embodiments, dispersed within the BNNT material. The ⁴He ions 14 and ⁷Li ions 15 may lose some of their energy in the BNNT material 13 with its boron, amorphous BN, and h-BN impurities, in addition to losing energy in the second scintillating material. In some embodiments, the thermal neutron detector may be designed such that most of the ionization occurs in the second scintillating material, and relatively small amounts of the ionization occur in the BNNT material 13 itself by having the mass of the second scintillating material higher than the mass of the BNNT material. The ratio of ionization in the BNNT material compared to the second scintillating material is controlled by the ratio of the respective masses of material present with some adjustment for the atomic numbers of the materials.

As seen in the geometry of FIG. 1, at least one of the ions is always depositing its energy in the crystal-coated BNNT material 13. Consequently, there is at least 0.84 MeV deposited in the ¹⁰BNNT if the bulk ¹⁰BNNT material is thicker than about 1 mg/cm², and there may be as much as 2.8 MeV deposited for some Events. U.S. Pat. 10,725,187, filed Aug. 28, 2019 and issued on Jul. 28, 2020, incorporated by reference in its entirety, addresses both optimizing the thickness(es) for generating the light and for collecting a sufficient fraction of the light in one or more photo detectors. Those techniques may be used in embodiments of the present approach.

Embodiments of the present approach may use various types of BNNTs, although embodiments using high quality BNNT material will have the greatest signal detection due to their optical transparency. BNNT, LLC (Newport News, Virginia) produces high quality BNNT material by high temperature, high-pressure (HTP) methods that may be used in embodiments of the present approach. The synthesis processes are catalyst-free, and the processes only use boron and nitrogen gas as feedstock. The BNNTs in high quality BNNT material have few defects, 1- to 10-walls with the peak in the distribution at 2-3-walls and rapidly decreasing with larger number of walls. BNNT diameters in these materials typically range from 1.5 to 6 nm, and they may extend beyond this range. Nanotube lengths in these materials typically range from a few hundreds of nm to hundreds of microns, and they may extend beyond this range.

The following paragraphs refer to as-produced BNNT material, which as used herein refers to the high quality BNNT material available from BNNT, LLC. For the as-produced BNNT material, the composition of the material greatly depends on the synthesis parameters and is mixture of high quality BNNTs, boron particles, amorphous boron nitride (a-BN), hexagonal BN (h-BN) h-BN nanocages, and h-BN nanosheets. The non-BNNT components of the as-produced material are typically a few 10 s of nm in size or less (e.g., about 10 to about 50 nm, and in some embodiments, about 20 to about 50 nm, and in some embodiments, about 30 to about 50 nm, wherein the term “about” in this context means +/- 0.3), but they may extend beyond this range. The production parameters of the HTP process can be adjusted to have more or less boron as compared to the a-BN and h-BN species.

The as-produced BNNT material is approximately 0.5 grams per liter (0.5 g/L), and may vary by +/- 50%. This value of the “tap density” can be compared to the density 2,100 g/L for h-BN. The as-produced BNNT material has the appearance of a “cotton ball” or “puffball.” BNNT material can equally well be made with natural boron or ¹⁰B or ¹¹B. In some embodiments, the BNNT material includes an enhanced concentration of ¹⁰B in the nanotubes. For example, BNNT, LLC (Newport News, Virginia) produces ¹⁰B-containing BNNT material, utilizing 96 wt.% enriched boron feedstock. It should be appreciated that an enhanced concentration of ¹⁰B may have more than 25% ¹⁰B, more than 30% ¹⁰B, more than 35% ¹⁰B, more than 40% ¹⁰B, more than 45% ¹⁰B, more than 50% ¹⁰B, more than 55% ¹⁰B, more than 60% ¹⁰B, more than 65% ¹⁰B, more than 70% ¹⁰B, more than 75% ¹⁰B, more than 80% ¹⁰B, more than 85% ¹⁰B, more than 90% ¹⁰B, or more than 95% ¹⁰B, all by weight. This specification refers to a BNNT material having an enhanced ¹⁰B concentration as ¹⁰BNNT, for shorthand. It should be appreciated that various levels of ¹⁰B-enriched feedstock are available, and other fractions may be used without departing from the present approach.

The puffball form-factor of ¹⁰BNNT has been useful for initial prototyping, but may have structural limitations for some embodiments of radiation and thermal neutron detectors. Further, boron particles in the BNNT material are preferably removed, because they are absorptive of the wavelengths of light of interest. Various purification or refinement processes can be used to remove (which, as used herein, includes significantly reduce the amount of) boron particulates in a high quality BNNT material, including those disclosed in International Patent Application No. WO 2018/102423 A1, filed Nov. 29, 2017, and incorporated by reference in its entirety. Generally, reducing the residual boron particle content of a BNNT material will improve the BNNT material’s use as a scintillator. In some embodiments, residual boron particles remaining after purification comprise less than 20 wt.% of the BNNT material, and in some embodiments the residual boron particles comprise less than 10 wt.% of the BNNT material, and in some embodiments the residual boron particles comprise less than 5 wt.% of the BNNT material, and in some embodiments the residual boron particles comprise less than 1 wt.% of the BNNT material, and in some embodiments the residual boron particles comprise less than 0.5 wt.% of the BNNT material. Further, the refining process can also be tuned to additionally remove the majority of a-BN, and if desired, some of the h-BN nanocages and h-BN nanosheets, particularly along their edges and near any defects. Unlike other refinement processes in the art, the refining processes referenced herein are not acid-based and do not introduce any metals into the final BNNT material. The following description refers to the as-synthesized BNNT material as Beta, the BNNT material with boron particles removed (i.e., at least under 20 wt.%) as Gamma or R, and the BNNT material with some removal of BN allotropes as Zeta or RX.

Three different forms of the as-synthesized ¹⁰BNNT material from BNNT, LLC (Newport News, Virginia) are described herein. First, the P1 series represents the original, as-produced BNNT material. The P2 series represents a tradeoff of having more boron particles but significantly less h-BN nanosheets. The SP-10 series is similar to P2, except it is produced by a high-throughput HTP process. The initial ¹⁰BNNT scintillation results reported below are with P1-Beta BNNT material where the Beta label indicates that the material was not refined to remove any of the boron particles.

With respect to BNNT material form-factors suitable for the present approach, a wide variety may be used, ranging from as-produced puff-balls, to BNNT mats, and BNNT buckypapers. BNNT buckypapers are well-suited for many embodiments of the present approach. A BNNT buckypaper may be formed through dispersing BNNT material in a solvent, filtering the BNNT dispersion, collecting BNNTs on a filter, and drying the solvent to form a solid BNNT buckypaper on the filter. BNNT buckypapers have been manufactured in a wide range of sizes, and from all the various BNNT materials referenced herein (e.g., P1, P2, SP-10, Beta, Gamma, and Zeta, R, and RX). The BNNT buckypapers used in various embodiments have a thickness from 10 to 200 microns. For an areal density near 1 mg/cm², the thickness is typically 10-20 microns, but other embodiments may extend beyond this range. For a BNNT buckypaper placed under high compressive force, the compressed thickness can become as low as 0.7 microns, however the BNNT buckypapers used in the embodiments discussed herein were not under external pressure. A 10 micron ¹⁰BNNT buckypaper is typically near 1 mg/cm², and absorbs 10% of the thermal neutrons impacting the surface.

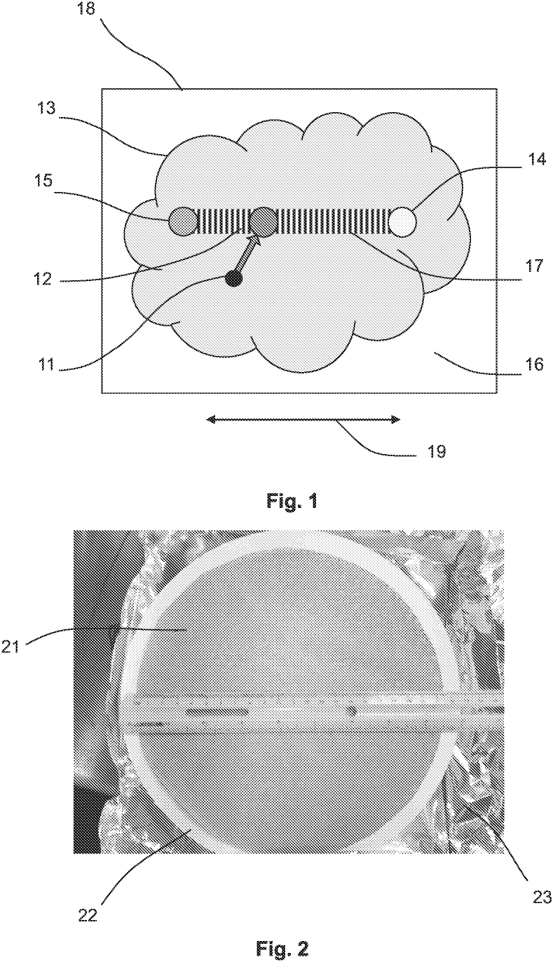

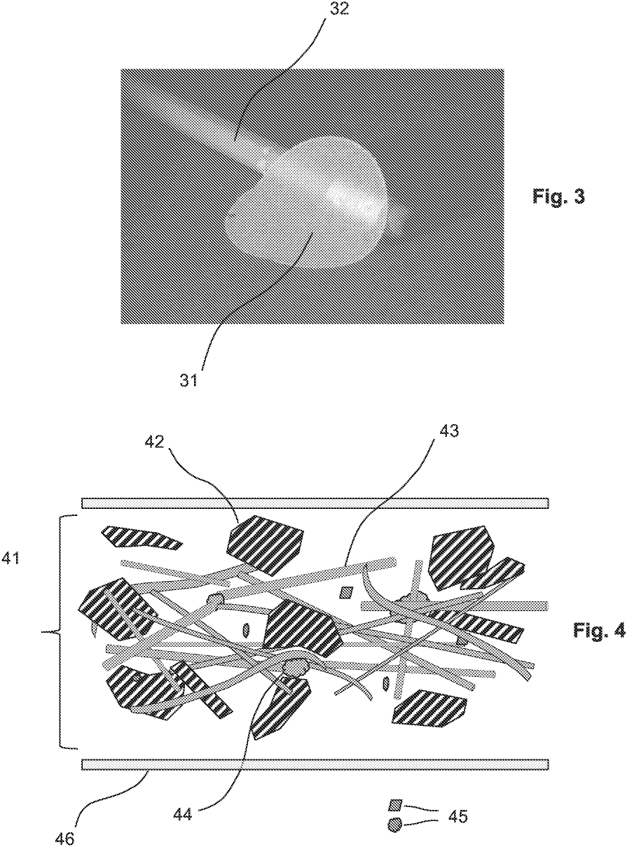

Various prototypes employing BNNT buckypapers have been evaluated. BNNT buckypapers having diameters of 3.5 cm and 7 cm were used in many of the prototypes, but other dimensions may be used in other embodiments. FIG. 2, for example, shows a BNNT buckypaper 21 with a 21.5 cm diameter, formed using BNNT material from BNNT, LLC. The BNNT buckypaper 21 is on a filter paper 22 and a sheet of aluminum foil 23. BNNT buckypapers have suitable optical properties for the present approach as shown in FIG. 3, with a 30 mm small, 1 mg/cm², 30 mm diameter P2 Zeta BNNT buckypaper 31 covering a portion of a pencil 32. As can be seen in FIG. 3, the pencil 32 is visible through the BNNT buckypaper 31. With the majority of boron particles, which varies depending on the as-produced BNNT material, but estimated at over 95 wt.% for the BNNT materials used in the prototypes described, removed by a refining process, the visible light is making it through the buckypapers with minor distortion, similar to light passing through slightly frosted glass.

FIG. 4 illustrates the intermixing 41 of scintillating crystals 42 into BNNT material that is comprised of BNNT nanotubes 43, nodes of h-BN 44 that may be present at the ends of BNNT nanotubes 43, and various particulates 45 of a-BN, h-BN nanocages, h-BN nanosheets, and in some embodiments boron particles that may join together to form the nodes of h-BN. All of these BN allotropes contribute ¹⁰B for the absorption thermal neutrons. In some embodiments, the scintillating crystals 42 may be pre-coated on the BNNT material, and in some embodiments the scintillating crystals 42 may be formed on and dispersed within the BNNT material.

The following paragraphs discuss four demonstrative approaches to introduce scintillating crystals 42 to the BNNT material. It should be appreciated that the person having an ordinary level of skill in the art may use an alternative approach to coat on, and/or disperse within, a second scintillating material to a BNNT material. In a first example, a crystal precursor material may be placed into a solution into which the BNNTs have been dispersed. Using anthracene as an example, anthracene may be dispersed into organic solvents such as ethanol and isopropyl alcohol (IPA), and then BNNTs may be stirred into the solution. Anthracene, a preferred second scintillating material in the present approach, has the highest scintillation light output of any organic scintillator for a given level of ionization. Depending on the BNNT material’s form-factor (e.g., whether the BNNTs are in a puffball or powder), the level of stirring or sonication of the mixture will vary as those of ordinary skill will appreciate. The mass ratio of scintillating precursor and BNNT material can be varied depending on the embodiment and the balance of ionization loss of the ⁴He and ⁷Li ions as discussed above. Typically, the mass ratio varies by at most a factor of two, but embodiments beyond this range can also be utilized if the ratio benefits the propagation of the light through the crystal-coated BNNT material. For example, anthracene will dissolve at 2 grams per liter of ethanol at room temperature, and 2 grams of BNNT material can be readily dispersed in ethanol by robust stirring of BNNT material, either as puffballs or powders. The anthracene-BNNT-ethanol mixture can then be placed on a target surface, such as a metal or plastic surface. In some embodiments, the surface may be a mold to shape the crystal-coated BNNT material into a desired form factor. The ethanol solvent may be removed, such as through evaporation, leaving an anthracene crystals coating on the BNNTs, and dispersed within the BNNT material. The process can be repeated multiple times on a surface, if desired, to produce the specific thickness of crystal-coated BNNT material layers.

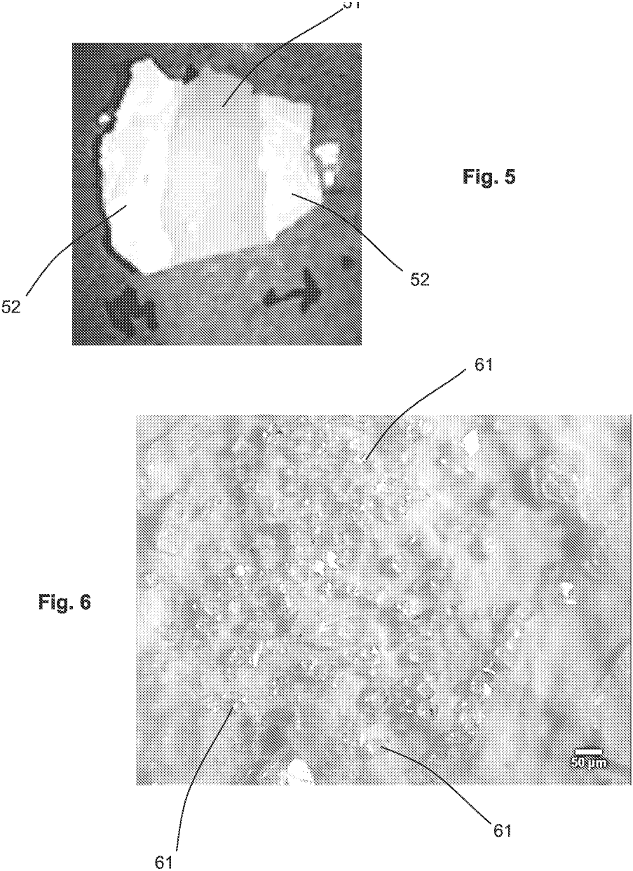

In second method of introducing the second scintillating material to BNNTs, a crystal precursor material in solution may be introduced to a BNNT buckypaper. In this method, a BNNT buckypaper is prepared from the BNNT material as described above and illustrated in FIGS. 2 and 3. A solution of the crystal precursor is poured onto the BNNT buckypaper, and the solution remains until the solvent is removed, typically by an evaporation process, resulting in both a coating and a dispersal of the second scintillating material. Coating the BNNTs in the BNNT buckypaper, and dispersing the crystal scintillator within the BNNT material, may be repeated to achieve the desired crystal loadings on the BNNTs and within the BNNT buckypaper. As referenced above, anthracene is a preferred second scintillating material, and may be used in this method of forming a crystal-coated BNNT material. This method may take place at room temperature, but can proceed at a faster rate if the materials are elevated by about 10-50 degrees centigrade. At some point in the process the anthracene-ethanol solution will cease penetrating the BNNT buckypaper, and the anthracene crystals will grow only on the surface. Crystal growth can be observed by the fine structure of the felt-like BNNT buckypaper surface becoming smoother though mottled with a coating of the anthracene crystals. An example from this process is shown in FIG. 5, in which an anthracene-ethanol solution was only placed along the left side 52 and right side 53 of a small roughly 1 cm wide fragment of BNNT buckypaper. At the early stage of the crystal coating process, the anthracene-ethanol solution was only going into the BNNT buckypaper, and not covering the BNNT buckypaper surface. The ratio of areal mass density was about one part anthracene crystals to 10 parts BNNT material. The left area 52 and right area 53 of the crystal-coated BNNT material that form the BNNT buckypaper are brighter in the image in FIG. 5 than the center of the fragment because a mostly UV light was used for illumination and the sides are glowing blue compared to BNNT buckypaper 51 without any anthracene crystals in the center.

FIG. 6 shows an optical microscope image of anthracene crystals 61 on BNNT buckypaper. The crystals have sizes ranging from a few microns to about 50 microns, although some may fall outside of this range. In the image, anthracene crystals 61 on the surface of crystal-coated BNNT material are visible. The crystals 61 formed after the process was repeated the level where an additional roughly 1 mg/cm² of anthracene crystals 61 was added to the surface of the BNNT buckypaper being used. As can be seen the crystals are typically a few microns to 50 microns in size (e.g., about 1 to about 5 µm, and in some embodiments, about 2 to about 5 µm, and in some embodiments, about 3 to about 5 µm, wherein the term “about” in this context means +/-0.3) with some of the crystals growing beyond this range. Typically, in particle and nuclear physics experiments when anthracene is used as a scintillator, great efforts are made to grow large crystals of several centimeters in length. However, as seen in FIG. 5 and as discussed below, the micron-scale (e.g., up to about 50 microns and sometimes beyond) anthracene crystals within the BNNT material function as scintillators, and micron-scale crystals are preferred for the present approach.

In the third demonstrative method of introducing a second scintillating material to BNNTs, the scintillating crystals are dry mixed into the BNNT material through one or more processes such as milling and robust stirring in a blender. This process may have advantages for shaping the scintillator materials into desired form-factors, and for working with second scintillating materials that do not readily go into solution, such as thallium-doped sodium iodide that may lose the thallium in the water typically used to dissolve sodium iodide, or such as cerium doped lutetium aluminum garnet (Ce:LuAG) ceramic that is formed at temperatures in excess 1700° C. and does not dissolve into solvents. Other non-limiting examples of second scintillating materials are described below. A potential disadvantage of this method, for some embodiments, is that the resultant material may not be adequately transparent to efficiently get the scintillation light to the photon detection components of the detector apparatus.

A fourth demonstrative method of introducing a scintillating material to a BNNT material is a variation on the first method, and is a preferred method for some embodiments. Anthracene is dissolved by stirring into IPA, or another solvent such as ethanol, methanol, hexanes, acetone, chloroform, or diethyl ether, at a level to be within 30 wt.% of its saturation for the temperature being utilized (e.g., often room temperature). BNNT material is separately placed into the same or a compatible solvent, which may be IPA, ethanol, methanol, hexanes, acetone, chloroform, diethyl ether, or another appropriate solvent, and then stirred for a sufficient time to breakup and suspend the BNNT puffballs or other starting material (e.g., for about 50 hours, about 60 hours, about 70 hours, about 80 hours, about 90 hours, or about 96 hours, or about 100 hours, wherein “about” in this context means +/- 2 hours). The solution of BNNT starting material may then be subjected to another mechanical dispersion technique, including, but not limited to bath sonication or probe sonication. There is typically 0.01-2 mg of BNNT material per mL of solvent. The dispersion of BNNT material and the anthracene solution are then combined at a target ratio of mass of BNNT to anthracene in the mixture (e.g., 1:1 to 1:2, although other ratios may be utilized depending on the desired result). Next water, or another solvent in which the anthracene is immiscible (typically <0.5 mg/mL at the temperature of interest), is added dropwise to the mixture of BNNT, anthracene, and IPA of sufficient quantity to precipitate the anthracene with stirring. The mixture is then stirred sufficiently to allow crystal formation (e.g., from 50 to 100 hours, such as about 50 hours, about 60 hours, about 70 hours, about 80 hours, about 90 hours, or about 100 hours, or about 96 hours, wherein “about” in this context means +/- 2 hours). As those of ordinary skill in the art will appreciate, the mole fractions, rates of solvent introduction, and temperature will affect the size and quality of the crystals in the solution-based crystal growth methods. Testing in the parameter space discussed above has shown that introducing water at a wt.% ratio of 2:3 within 15 seconds to a minute will generate anthracene crystals typically less than 5 microns in size with most of them below 1 micron in size that work for generating light in a neutron detector. Vacuum filtration may then be utilized for extracting the mixture of BNNT material, anthracene, and anthracene-coated BNNT material, resulting in a BNNT buckypaper having a crystal coating and crystal dispersed within the BNNT material. The thickness of the BNNT buckypaper prepared using this approach is in the range of 10-100 microns, and the volumetric density is in the range of 0.1-0.8 g/cm³ but may extend beyond these ranges in other embodiments. It should be appreciated that this approach, utilizing anthracene, will work for other second scintillating materials may be precipitated in solution with the use of appropriate solvent systems.

There are a variety of scintillator materials that may be used as a second scintillator material. With respect to organic crystals, many are aromatic hydrocarbons having benzene rings in various interlinked patterns. Examples of organic crystal scintillators include anthracene, stilbene, and naphthalene. Anthracene has been used in the example discussed herein because as discussed above it generates more light for a given level of deposited ionization than any other organic scintillator, and it has been used in initial testing because it readily dissolves in ethanol and IPA and is easy to work with in the lab environment. However, there are more the twenty other commonly used organic scintillators and roughly the same number of inorganic scintillators that can be utilized, such as those available from Hilger Crystals (Concord, MA), and Saint-Gobain Crystals (Milford, New Hampshire). Other examples include Bismuth Germanate (BGO) -Bi4Ge3O12, Cadmium Tungstate - CdWO4, CLYC - Cs2LiYC16(Ce), Europium-doped Calcium Fluoride - CaF2(Eu), GLuGAG - (Gd,Lu)3,(GaAl)5,O12(Ce), Lutetium Yttrium Silicate (LYSO), Sodium-doped Caesium Iodide - CsI(Na), Sodium Iodide - NaI, Thallium doped Caesium Iodide - CsI(Tl), Thallium doped Sodium Iodide - NaI(Tl), Yttrium Aluminium Garnet (YAG), Yttrium Aluminium Perovskite (YAP), and Zinc Tungstate. It should be appreciated that the third method for forming crystal-coated BNNT scintillating materials described below may be appropriate for these inorganic crystal scintillating materials. Anthracene may not be preferred for environments where the crystal-coated BNNT material will need to be in ultra-high vacuum (UHV) such as in a particle beam line in an accelerator, or the materials will need to be at high temperature such as in a down-hole drilling system that may be kilometers below the surface. Fortunately, BNNT material survives to over 700° C. in most environments and frequently to much higher temperature, e.g. 1500° C., in some environments such as vacuum or nonreactive gases such as argon and nitrogen. Consequently, scintillating crystals appropriate for these environments can be utilized and higher temperature growing systems such as vapor deposition can be utilized or the mixing methods discusses above as the third method which may be appropriate for when a ceramic scintillator is used for the crystal-coating of the BNNT material. An addition comment on anthracene, is that it works well in air and any other environment where it does not chemically interact. This aids in the manufacturability of detectors.

The thermal neutron cross section area (TNCSA) of one mole of ¹⁰B (10 g) is 6.022x10²³ atoms/mol × 3835 barns/atom = 0.23 m²/mol where 1 barn = 10⁻²⁸ m². For comparison, the ³He TNCSA is 0.32 m²/mol. High quality BNNT material will be more cost-effective than ³He, based on at least the amount needed for a square meter. Additionally, ¹⁰BNNT material can be more efficiently deployed. Thermal neutron detectors are frequently rated by cps/nv (counts per second per a flux of 1 neutron per square centimeter second). Using this metric, simply increasing the size of the detector increases the cps/nv rating. A thermal neutron efficiency rating, TNE, for the utilization of the material can be developed by dividing the cps/nv rating by the TNCSA required to achieve this rating. By this TNE rating, based on available information, typical cylindrical ³He detectors have a TNE of 4,635 to 4,676 for the 2.7 atm detectors (ones that can be easily shipped because their internal pressure is below 40 psi (276 kPa) a limit for transportation safety in some countries). The high pressure ³He detectors only have TNE ratings of 3,334 at 10 atm ³He and 1,795 for 20 atm ³He. This lower performance at high pressure is because the ³He gas as the center of the detectors is shielded by the gas near the surface. The TNE rating for manufacturable ¹⁰BNNT thermal neutron detectors according to the present approach will be above at least 5,000.

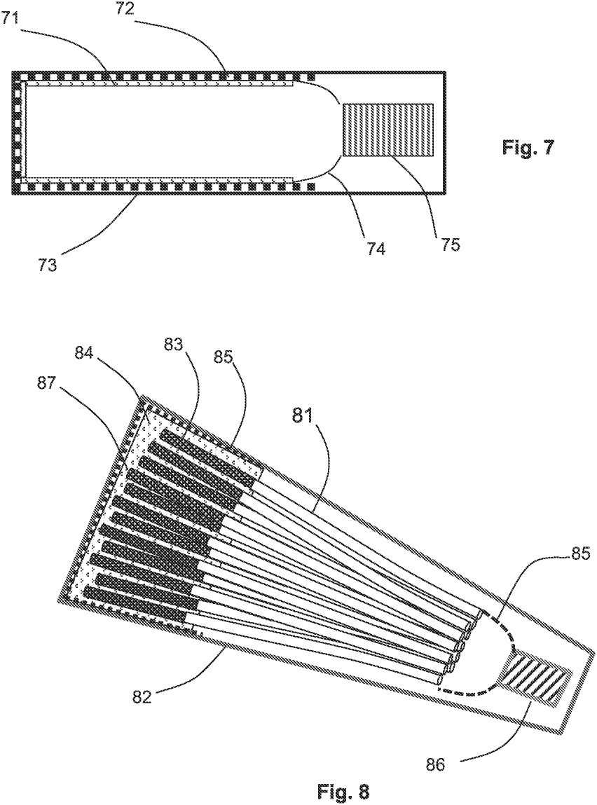

The detector geometry used for the initial testing of anthracene based crystal-coated BNNT material is illustrated in FIG. 7. Utilizing the second method discussed above, BNNT buckypapers 71 slightly above 1 mg/cm² were infused with anthracene-loaded ethanol to about the same areal density of anthracene crystals 72 once the ethanol evaporated, and then coated with an additional roughly 1 mg/cm² of anthracene crystals via the second method described above. The additional anthracene crystal only layer 72 is so that the ⁴He and ⁷Li ions from Events that leave the outer surface of the crystal-coated buckypaper in the direction of the chamber all transit and are then stopped in scintillating crystals. Light from the Events scatter around within the chamber 73 and are directed by the compound parabolic concentrator (CPC) onto the photo detector 75, either a SiPM or PMT. The inner surfaces of both the chamber 73 and the CPC are aluminum because the material is nearly 99% reflective of the blue wavelengths of light that anthracene predominantly emits in the scintillation process.

The following paragraphs describe prototype neutron testing. The ADC used was a CAEN DT5730. The photo detectors were a SensL ArrayC-60035 quad SiPM and a Hamamatsu R6094 PMT. Both are sensitive to blue photons. The source of neutrons for these tests was an AmBe source plus natural background. Cosmic ray interactions with the atmosphere and materials near the surface of the earth are the primary source of thermal neutrons on the surface of the earth. This thermal neutron flux is estimated at 7 neutrons/m²/s for Newport News, VA but can vary significantly and beyond this range depending on surrounding material, elevation, latitude and other location specific conditions. The natural background was anticipated to contribute 0.4 counts per minutes (CPM) for the PMT configuration tested. The AmBe source was not calibrated, so all of the measurements are relative. The detectors were shielded by a combination of iron, lead and tungsten shielding to eliminate the gamma ray background from the AmBe source. Three amounts of high density polyethylene (HDPE) were placed around the detectors to thermalize the epithermal and fast neutrons from the AmBe source: 0”, 1” and 2”. For the PMT the measured rates are shown in Table 1.

TABLE 1

PMT Results

| Source | HDPE Thickness (inches) | Counts per Minute |
|---|---|---|
| AmBe | 2” | 47 |
| AmBe | 1” | 26 |
| AmBe | None | 12 |
| None | 2” | 7 |

The PMT detector efficiently detected the thermal neutrons as indicated by the variation of observed rate with the thickness of the HDPE that thermalized the neutrons from the AmBe source. There was a background in the overall system as observed by the 7 CPM of the no source rate being above the anticipated natural background rate. The full width at half max of the pulses observed were typically between 10 and 20 nanoseconds. This points to sub-10 nanosecond coincidence capabilities for segmented detectors with multiple Events.

The anthracene crystal-coated BNNT material in the SiPM detector system was less than about half of the amount of crystal-coated BNNT material used for the PMT system and covered roughly one third the area with about half the amount of ¹⁰B present. The SiPM used had a very high noise rate in each of the four elements of the quad SiPM so they were put in coincidence utilizing constant fraction discrimination. At least two of the four elements had to have a signal to indicate an Event. The coincidences occurred within a 10 nanosecond window. To determine the base rate from the random coincidences between the elements of the SiPM, the SiPM was covered so it could not collect light from the surroundings, and under these conditions it counted at 119 CPM. This rate was dependent on the bias voltage applied to the SiPM. The challenge of high noise rates in SiPMs is well known by those of ordinary skill in working with them, and future planned work will be with SiPMs that are far less noisy for this application.

Table 2 shows the SiPM results. The Event rate was near a factor of four below that of the PMT rate. This is very roughly a factor of two below the anticipated rate. The discrepancy is believed to be mostly a factor of the issue of noise discussed above in the system as the Event rates were a factor of more than ten below the noise coincidence rate. The half width of the pulses observed was near 100 nanoseconds. Again, the SiPM system was not well optimized for the measurement and while the timing was better than 10 nanoseconds, the pulse widths would ideally be narrower. However, the pattern seen with the PMT of the variation in rates between, 0”, 1” and 2” of HDPE was well observed.

TABLE 2

SiPM Results

| Source | HDPE Thickness (inches) | Counts per Minute |
|---|---|---|
| AmBe | 2” | 10 |
| AmBe | 1” | 7 |
| AmBe | None | 5 |
| None | SiPM covered | 3 |

While PMTs, as demonstrated, can be used as effective detectors of thermal neutrons in the crystal-coated BNNT material, they have disadvantages of being relatively large and heavy, and they require high voltage, e.g. typically 500 to 1000 volts, and too much power. SiPMs are small, require less than 100 V (typically only 25 V to 50 V) and operate at low power. Both PMTs and SiPMs can have sub 10 nanosecond timing capabilities. However, SiPMs while having good sensitivity to photons also have a higher level of noise than PMTs as discussed above.

The rise time sensitivities of both PMTs and SiPMs is less 10 nanoseconds. The recovery times is dominated by the scintillation times of the crystals employed and the capacitance of the SiPM on the inputs of the preamplifiers. Using anthracene as the crystal scintillating material, the total times of the pulses is well under several hundred nanoseconds. Consequently, maximum detection rates can approach 1 MHz. Some scintillating crystals have much longer decay times and the maximum detection rate will be less.

The full range of measurements planned in 2020 were interrupted by the pandemic, but measurements with SiPMs discussed above with the geometry illustrated in FIG. 7 and the anthracene-coated BNNT material prepared using the fourth method discussed above with SP10-R BNNT material were achieved. The improved material performed roughly four times better than the prior material prepared by the second method discussed above. This indicates that it performed at a level near that of the PMT performance.

In addition to improving the scintillating materials, another aspect of achieving a successful neutron detector under the present approach is to optimize the collection and transport of the light from the scintillating process to the SiPM or PMT. Fiber optic side-glow cables are typically used for specialty lighting where typically an LED is placed on the end of a frosted or surface modified fiber optic cable and light is emitted along the frosted section. In some embodiments, an inverse version of this configuration may be used, wherein a fiber optic cable has a frosted section, or partially frosted section and light flows from the frosted section of the cable to the unfrosted end of the cable. These cables may be made of glass, or polymers such as PMMA, polystyrene, or other materials that have high, if not total, internal reflection. This embodiment is referred to as the fiber optic inverse side-glow (FOIS) arrangement. For the light that goes into the frosted section, a portion of this light enters the unfrosted section of the cable as a totally internally reflected and transported stream of photons and it can be detected by a photo detector such as a SiPM or PMT. With the copious amounts of light observed from Events in the crystal-coated BNNT material, such embodiments are practical. Some thermal neutron detection requirements benefit from submillimeter resolution of the Event location or for large area detectors centimeter and beyond resolution. With crystal-coated BNNT material being the source, location of the thermal neutron Event becomes possible in the FOIS arrangement.

FIG. 8 illustrates an embodiment of an FOIS neutron detector. Multiple individual FOIS cables 81 are placed in a chamber 82. As the FOIS cables 81 can be of diameters that are less than a mm (e.g., about 0.5 to about 5 mm, and in some embodiments, about 2 to about 5 mm, and in some embodiments, about 3 to about 5 mm, wherein the term “about” in this context means +/- 0.3), they can be flexible over the length of the chamber and the chamber can be in any shape including any length that supports the FOIS cables 81. The frosted sections 83 of the FOIS cables are covered with scintillator crystal coatings and/or crystal-coated BNNT material 84. In some embodiments, frosting of the cable itself is not required if the scintillator crystal-coating without the BNNT material is initially deposited directly on the FOIS cables 81 it will create the equivalent optical conditions of the frosting the FOIS cables themselves. The level of optical coupling between the light in the crystal-coated BNNT material 84 and either the frosting of the FOIS cables or the initial covering by the crystal coating of the FOIS cables determines the length of the frosted sections 83. The thickness of the crystal-coating should be near 1 mg/cm² so that all of the energy of the ⁴He and ⁷Li ions is collected before any of them reach the FOIS cable. This is typically only a 5-20 microns in thickness for the crystal coating for most scintillators. In tests with 4 mm diameter FOIS cables, it was observed that there was only a 20% variation in light transported to the output to the totally internally trapped modes for a 50% frosted section of 10 cm length. When the 10 cm length was 100% frosted the variation increased to near 50%. The frosting for this measurement was done by sandblasting. The most efficient collection of light from the FOIS cable occurs when the level of frosting plus scintillating crystals on the surface of the cable is such that if operated in a side-glow configuration 50% of light entering one end of the FOIS cable would exit the cable in the frosted region of the cable. This criterial allows for easy testing of the level of crystal-coating and frosting of the FOIS cables. In a given embodiment, the levels of frosting, application of crystal-coating to the surface of the FOIS cable 81 in the frosted section 83, and FOIS cable 81 diameters must be tested to meet the specific detector requirements for light output. As is well known by those of ordinary skill for working with side-glow fiber optic cables, these cables can be procured with different levels of frosting so as to be able to efficiently produce the glow effect over a variety of distances from centimeters to many meters. FOIS uses the inverse of this concept to pump the light in the reverse direction and measurement of the parameters indicated above must be performed to optimize the level of frosting by sandblasting, chemical means, crystal coating or direct application of the crystal-coated BNNT material 84. The optimal level of frosting collects the maximum amount of light from Events in the crystal-coated BNNT material 84 surrounding the frosted section of the FOIS cables 81. Additionally, a crystal coating 85 at 1 mg/cm² can be evaporated as an outer layer in the region of the frosted section of the detector to ensure that all of the ⁴He and ⁷Li ions interact with scintillator crystals before reaching the walls of the chamber 82. When anthracene is used for the second scintillating material, the inner side of the chamber 82 is usually aluminum because of its high optical reflectivity as discussed above. Additionally, this inner crystal layer 85 can be directly applied to the aluminum inner layer of the chamber, and frequently the chamber itself can be aluminum but this is not required. Further, the end 87 of the FOIS cable is coated with reflective material such as aluminum to reflect light back and transport it in the direction of the photon detector 86.

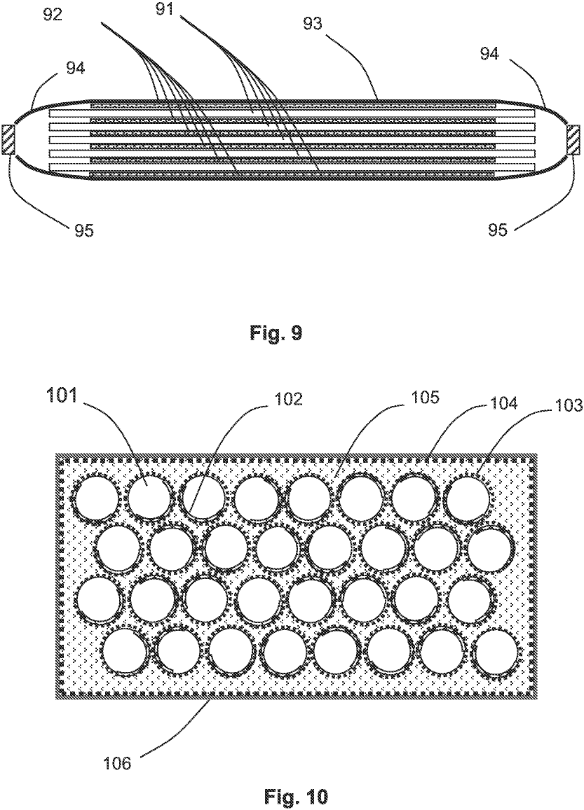

FIG. 9 illustrates an embodiment of a FOIS based detector utilizing SiPMs or PMTs. FOIS cables 91 with sections 92 of crystal-coated BNNT material and frosted cable are within a reflective chamber such as aluminum 93 that has optical collectors 94 that bring the light to SiPMs or PMTs 95. The overall size of the embodiment can be varied from less than a cm across to meters across and the diameters of the FOIS cables can cover the full range discussed above. In some embodiments, the SiPM or PMTs can be segmented or multiple SiPMs and PMTs can be utilized such as to improve the spatial resolution of the detected Events and in some embodiments the directions of alternative layers can be at angles to allow for the spatial resolution detection of the Events in two dimensions. Additionally, in some embodiments PMTs with segmented photocathodes may be utilized.

FIG. 10 illustrates a perpendicular cross section of the crystal-coated BNNT material 104 section of a FOIS detector with the geometry shown in FIGS. 8 and 9. In the embodiment illustrated in FIG. 10 the FOIS cables 101 have been 50% frosted 102 along the section of the FOIS cables 101. In addition, the FOIS cables 101 have been crystal-coated 103 at 1 mg/cm² so that all of the energy of the ⁴He and ⁷Li ions is collected before any of them reach the FOIS cable 101. In this embodiment, the crystal-coated BNNT material 104 is evaporated or deposited onto the FOIS cables 101 and evaporated around them. Additionally, a crystal-coating 105 at 1 mg/cm² is evaporated as an outer layer to ensure that all of the ⁴He and ⁷Li ions interact with scintillator crystals before reaching the walls of the chamber 106. When anthracene is used for the crystals, the inner side of the chamber 106 is usually aluminum because of its high optical reflectivity as discussed above. Additionally, this inner crystal layer 105 can be directly applied to the aluminum inner layer of the chamber, and frequently the chamber itself is aluminum. Care must be taken to minimize the amount of air or other gas present because 1 cm of air will also stop the ⁴He and ⁷Li ions so while air is okay in the detectors with anthracene, its volume should be minimized in the region near the crystal-coated BNNT material 105.

The geometries of the FOIS cables illustrated in FIGS. 8, 9 and 10 have the FOIS cables aligned with each other. Alternate geometries can be utilized. For example, in some embodiments alternate layers can be at 90 degrees to each to make an X-Y FOIS neutron detector. Half the scintillation light from a thermal neutron capture Event goes into the X axis FOIS elements and half goes into the Y axis elements. Position sensitive PMTs or SiPMs can be utilized to gather the FOIS cable by FOIS cable light intensities and thereby determine the X, Y and Z positions where Z represents the distance from the source of events to the location within the detector. If the embodiment utilizes FOIS cables near 1 mm diameter, then the light from and Event will go to several FOIS cables and the X-Y coordinates can be determined 1 mm or less in X, Y and Z from the location of the Event in the detector.

When the total of the crystal-coating on the BNNT materials is near 11 mg/cm² for the content of BN allotropes including BNNTs, the thickness will be near 0.5-1 mm, not including the FOIS cables. At this areal density roughly 63% of the thermal neutrons impacting on detector will result in Events. If the thickness of the BN allotropes is doubled (or, in some embodiments, tripled), then the Event efficiency will increase to near 87% (or 95%). Consequently, while large surfaces, e.g. meters squared and larger may be covered by the detector, the thickness can be made as thin as a few mm (e.g., about to about 5 mm, or in some embodiments, about 2 to about 5 mm, or in some embodiments, about 3 to about 5 mm, wherein the term “about” in this context means +/- 0.3). This can be important for making large area portal monitors, space radiation detectors and some scientific measurements. Additionally, the materials can be at atmospheric pressure, as well as above and below this pressure, and the materials are lightweight and nontoxic. If high temperatures are required such as in down-hole systems, the crystals can be inorganic, the FIOS cables can be glass, and the cables can be multiple kilometers in length so that the temperature sensitive photo detectors are at ground/surface levels. Additionally, as discussed above the Events can be timed to less than 10 nanoseconds when this is important for the specific application.

If three of these relatively thin crystal-coated BNNT material FOIS cable layers are made into planes, then directional detectors can be created by having the three planes orthogonal to each other. With this geometry the source direction(s) can be determined. For example, this may be useful for satellite applications observing the surface of the Earth. If hydrogen rich layers of a material a few centimeters thick (e.g., about 1 to about 5 cm, and in some embodiments, about 2 to about 5 cm, and in some embodiments, about 3 to about 5 cm, wherein the term “about” means +/- 0.2), such as HDPE, are placed in between and outside the layers in the planes of the layers, then fast neutrons are both attenuated and moderated to become thermal neutrons. A mapping of Events that can be used to determine the direction of the source of fast neutrons in applications such as portal monitors and satellite observations.

It should be appreciated that the previous discussion identified numerous embodiments of the present approach. Indeed, a number of geometries are possible with this technology:
Standard cylindrical formats compatible with existing ³He form-factors for ³He pressures up to 10 atmospheres.
Rectangular versions of the ³He cylindrical formats for up to a 27 percent improvement in volume performance. These, as well as the cylindrical format ¹⁰BNNT detectors, will be light weight and useful for a wide variety of applications from hand-held and backpack devices to drone devices to large area portal monitors.
FOIS components for high spatial resolution detectors. Examples include: ¹⁰BNNT FOIS directional thermal neutron detector for use in satellites, scientific experiments at spallation neutron sources, and possibly portal monitors. FOIS high temperature downhole neutron detector for deep well mining to determine local materials content and character including porosity, salinity, elemental composition, and oxygen, water and hydrocarbon content information. A key issue for these detectors is the need to operate at high temperature. The frosted FOIS section of the detector can be of any length, e.g. centimeters to meters, and the light cable fiber optic section can be kilometers. The detector can be segmented. As discussed above, all of the electronics can be on the surface, i.e. ambient conditions. Everything at depth is passive and can operate at elevated temperatures to at least 700° C. FOIS neutron probe for measuring moisture content from thermalized neutrons from fast neutrons generated by an AmBe source as typically utilized for ground measurements. Ambient neutrons generated by cosmic rays and also be utilized for determining ground water content over areas typically of several hundred meter scale. Fortunately, the BNNT-based neutron detector technology will scale across these many orders of magnitude. For deploying BNNT based items in the R&D stage, no additional certifications are required.
The FOIS technology as well as well as the sheets of neutron absorbing material as discussed for FIG. 7 can also be adapted to BN materials that are not BNNT material. For example, BN powders and BN sheets (BNNS) can also function as neutron detectors. Thin layers of BN can be deposited on both metal and plastic surfaces by evaporation and CVD processes. In turn these can be crystal coated with scintillating crystals. Non-BNNT allotropes can be mixed, as discussed above, with scintillating crystals. However, BNNT material will be generally the preferred embodiment as it is typically more translucent than the BN powders, adequately thick layers of BNNS and other allotropes of BN.

The present approach may be embodied in forms other than as disclosed in the various embodiments, as will be appreciated by those having an ordinary level of skill in the art. The present embodiments are therefore to be considered in all respects as illustrative and not restrictive.

1. A boron nitride nanotube (“BNNT”)-based scintillating material comprising:
a BNNT material comprising a plurality of BNNTs, and
a crystalline scintillating material,
wherein the crystalline scintillating material is at least one of a coating on the BNNTs, and dispersed within the BNNT material.

2. The BNNT-based scintillating material of claim 1, wherein the BNNT material comprises BNNTs having an enhanced fraction of ¹⁰B.

3. The BNNT-based scintillating material of claim 2, wherein the enhanced fraction of ¹⁰B is one of at least 50% by weight, 60% by weight, 70% by weight, 80% by weight, 90% by weight, and 95% by weight.

4. The BNNT-based scintillating material of claim 1, wherein the crystalline scintillating material is one of anthracene, stilbene, and naphthalene.

5. The BNNT-based scintillating material of claim 1, comprising a second layer of a BNNT material and a crystalline scintillating material, wherein the crystalline scintillating material is at least one of a coating on the BNNTs, and dispersed within the BNNT material.

6. The BNNT-based scintillating material of claim 1, wherein the BNNTs in the BNNT material are aligned in a first direction.

7. The BNNT-based scintillating material of claim 1, wherein the BNNT material is a BNNT buckypaper.

8. The BNNT-based scintillating material of claim 1, wherein the BNNT material has a residual boron content of one of less than 20% by weight, less than 10% by weight, less than 1% by weight, and less than 0.5% by weight.

9. A boron nitride nanotube (“BNNT”)-based neutron detector comprising:
a chamber;
at least one photon detector positioned in the chamber;
a BNNT-based scintillating material positioned in the chamber;
wherein the BNNT-based scintillating material comprises a BNNT material and a crystalline scintillating material, and the crystalline scintillating material is at least one of a coating on the BNNTs, and dispersed within the BNNT material;
wherein the at least one photon detector is positioned for detection of at least a portion of photons emitted from ions traversing the scintillating material produced by neutron absorption in the chamber.

10. The BNNT-based neutron detector of claim 9, wherein the BNNT-based scintillating material is the BNNT-based scintillating material.

11. The BNNT-based neutron detector of claim 9, wherein the chamber further comprises at least one mirror surface positioned to reflect photons toward the at least one photon detector.

12. The BNNT-based neutron detector of claim 9, wherein the BNNT-based scintillating material comprises a plurality of layers, each layer comprising a BNNT material having a coating of a crystalline scintillating material selected from anthracene, stilbene, and naphthalene.

13. The BNNT-based neutron detector of claim 9, wherein the BNNT material is a BNNT buckypaper.

14. The BNNT-based neutron detector of claim 9, wherein the BNNT material has a residual boron content of less than 20% by weight, less than 10% by weight, less than 1% by weight, and less than 0.5% by weight.

15. The BNNT-based neutron detector of claim 9, further comprising at least one fiber optic inverse side-glow (FOIS) cable positioned to transport collected light to the at least one photon detector.

16. The BNNT-based neutron detector of claim 15, wherein the FOIS cable comprises a frosted portion having a coating of one of a crystalline scintillating material, and a BNNT material having a coating of a crystalline scintillating material.

17. A method for producing a boron nitride nanotube (“BNNT”)-based scintillating material, the method comprising:
dispersing a BNNT material in a solvent;
dispersing a crystal precursor in the solvent, wherein the crystal precursor is a scintillating material;
pouring the dispersed BNNT material and dispersed crystal precursor onto a surface;
evaporating the solvent to form a crystal-coated BNNT scintillating material on the surface.

18. The method of claim 17, wherein the crystal precursor comprises one of anthracene, stilbene, and naphthalene.

19. The method of claim 17, wherein the solvent comprises an organic solvent.

20. The method of claim 17, wherein pouring the dispersed BNNT material and dispersed crystal precursor onto a surface and evaporating the solvent to form a crystal-coated BNNT scintillating material on the surface, are performed a plurality of times to form a layered crystal-coated BNNT scintillating material.

21. The method of claim 17, wherein the BNNT material comprises BNNTs having an enhanced fraction of ¹⁰B.

22. The method of claim 17, wherein the BNNT material has a residual boron content of less than 20% by weight, less than 10% by weight, less than 1% by weight, and less than 0.5% by weight.

23. A method for producing a boron nitride nanotube (“BNNT”)-based scintillating material, the method comprising:
dispersing a crystal precursor in a solvent, wherein the crystal precursor is a scintillating material;
pouring the dispersed crystal precursor over a BNNT material;
evaporating the solvent to form a crystal-coated BNNT scintillating material.

24. The method of claim 23, wherein the crystal precursor comprises one of anthracene, stilbene, and naphthalene.

25. The method of claim 23, wherein the solvent comprises an organic solvent.

26. The method of claim 23, wherein pouring the dispersed crystal precursor onto the BNNT material and evaporating the solvent are performed a plurality of times to form a layered crystal-coated BNNT scintillating material.

27. The method of claim 23, wherein the BNNT material comprises BNNTs having an enhanced fraction of ¹⁰B.

28. The method of claim 23, wherein the BNNT material has a residual boron content of less than 20% by weight, less than 10% by weight, less than 1% by weight, and less than 0.5% by weight.

29. The method of claim 23, wherein the BNNT material comprises a BNNT buckypaper.

30. A method for producing a boron nitride nanotube (“BNNT”)-based scintillating material, the method comprising:
dispersing a BNNT material in a first solvent to form a first solution;
dispersing a crystal precursor in a second solvent to form a second solution, wherein the crystal precursor is a scintillating material;
combining the first solution and the second solution at a desired ratio to form a combined solution;
incrementally adding to the combined solution a third solvent in which the crystal precursor is immiscible, to induce crystal formation;
extracting the first solvent, the second solvent, and the third solvent, to form a crystal-coated BNNT material.

31. The method of claim 30, wherein the crystal precursor comprises one of anthracene, stilbene, and naphthalene.

32. The method of claim 30, wherein the third solvent comprises water.

33. The method of claim 17, wherein extracting the first solvent, the second solvent, and the third solvent, comprises vacuum filtration, and the crystal-coated BNNT material comprises a crystal-coated BNNT buckypaper.

34. The method of claim 30, wherein the BNNT material comprises BNNTs having an enhanced fraction of ¹⁰B.

35. The method of claim 30, wherein the BNNT material has a residual boron content of less than 20% by weight, less than 10% by weight, less than 1% by weight, and less than 0.5% by weight.
